(19) United States
(12) Patent Application Publication
(10) Pub. No.: US 2024/0429691 A1
(43) Pub. Date: Dec. 26, 2024

(54) CABLE TRANSITION SYSTEMS

(71) Applicant: SHOALS TECHNOLOGIES GROUP, LLC, Portland, TN (US)

(72) Inventor: Dorothy Michael, Greenbrier, TN (US)

(73) Assignee: SHOALS TECHNOLOGIES GROUP, LLC, Portland, TN (US)

(21) Appl. No.: 18/749,390

(22) Filed: Jun. 20, 2024

Related U.S. Application Data
(60) Provisional application No. 63/509,739, filed on Jun. 22, 2023.

(51) Int. Cl. H02G 3/04

(52) U.S. Cl. CPC H02G 3/0437

(57) ABSTRACT

A cable transition system may include sidewalls and a top wall coupled to the sidewalls. The top wall may couple to the plurality of sidewalls to define a first volume extending along a first plane. The first volume may route a part of a cable along the first plane. The top wall may couple to the plurality of sidewalls to define a second volume extending along a second plane that is non-parallel to the first plane. The second volume may route a part of the cable along the second plane. In addition, the top wall may couple to the plurality of sidewalls to define a transition volume connected to the first volume and the second volume. The transition volume may route a part of the cable between the first volume and the second volume to permit the cable to extend along the first plane and the second plane.

### CROSS-REFERENCE TO RELATED APPLICATION

This patent application claims the benefit of and priority to U.S. Provisional App. No. 63/509,739 filed Jun. 22, 2023, titled “CABLE TRANSITION SYSTEMS,” which is incorporated in the present disclosure by reference in its entirety.

### FIELD

The embodiments discussed in the present disclosure are related to cable transition systems.

### BACKGROUND

Unless otherwise indicated in the present disclosure, the materials described in the present disclosure are not prior art to the claims in the present application and are not admitted to be prior art by inclusion in this section.

A power installation may include a component that is installed on a wall surface (e.g., a generally vertical surface) and a component that is installed on a ground surface (e.g., a generally horizontal surface). The components installed on the wall surface may be electrically coupled to the component installed on the ground surface via one or more cables. A large portion of costs to deploy the power installation may be associated with temporal aspects of routing and managing the cables of the power installation. For example, to route the cables to the component installed on the wall surface, openings may be created in the wall surface to route the cables behind the wall surface. The openings in the wall surface may be covered to prevent access to the cables behind the wall surface. As another example, to route the cables to the component installed on the ground surface, trenches may be dug to route the cables beneath the ground surface. The trenches may be covered to prevent access to the cables or injury to people traversing the trenches. Creating the openings in the wall surface and digging the trenches may increase the costs to deploy the power installation due to the use of power equipment and time spent.

Accordingly, there is a need for a power installation that routes and manages cables in a manner that reduces the deployment costs, does not limit the location at which the power installation may be deployed, or does not limit the size of the power installation.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments of the present disclosure address the problems with deploying the power installation with components mounted to the wall surface and the ground surface. In particular, some embodiments of the present disclosure permit the power installation to be installed without digging trenches, creating the openings in the wall surface, limiting the location at which the power installation may be deployed, or limiting the size of the power installation. Disclosed embodiments include a cable transition system (CTS) that couples to a cable management system (CMS) to create a contiguous volume along a plane of the ground surface, along a plane of the wall surface, and between the plane of the ground surface and the plane of the wall surface. The cables may be routed through the volumes of the CMS and the CTS (e.g., the contiguous volume) along the ground surface and the wall surface. In addition, the CTS may interface with the CMS and may interface with a transition between the wall surface and the ground surface such that the cables are protected from external loads and/or exposure factors. For example, the CTS and/or the CMS may protect the cables from vehicular traffic, pedestrian traffic, other traffic, external loads, tampering, or other exposure factors.

The CTS may define a first volume that extends along the plane of the ground surface. The CTS may also define a second volume that extends along the plane of the wall surface. In addition, the CTS may define a transition volume that connects the first volume and the second volume. The CTS may route the cables from the first volume to the second volume via the transition volume to permit the cables to be routed along the wall surface and along the ground surface.

Therefore, the CTS and the CMS may eliminate the need for digging trenches and/or creating openings in the wall surface without limiting the location at which the power installation may be deployed or limiting the size of the power installations.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example electric vehicle (EV) charger system installed at a location that includes a wall surface, a ground surface, and a transition between the wall surface and the ground surface;

FIGS. 2A-2F illustrate a left perspective view, a right perspective view, a top view, a bottom view, a front view, and a back view of an example CTS of FIG. 1;

FIGS. 3A and 3B illustrate a left perspective exploded view and a right perspective exploded view of the CTS of FIGS. 2A-2F;

FIG. 4 illustrates a cross sectional view of the CTS of FIGS. 2A-2F routing the cable of FIG. 1 along with the wall surface, the ground surface, and the transition between the wall surface and the ground surface; and

FIGS. 5A and 5B illustrate a left perspective view and a right perspective view of another example CTS;

all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

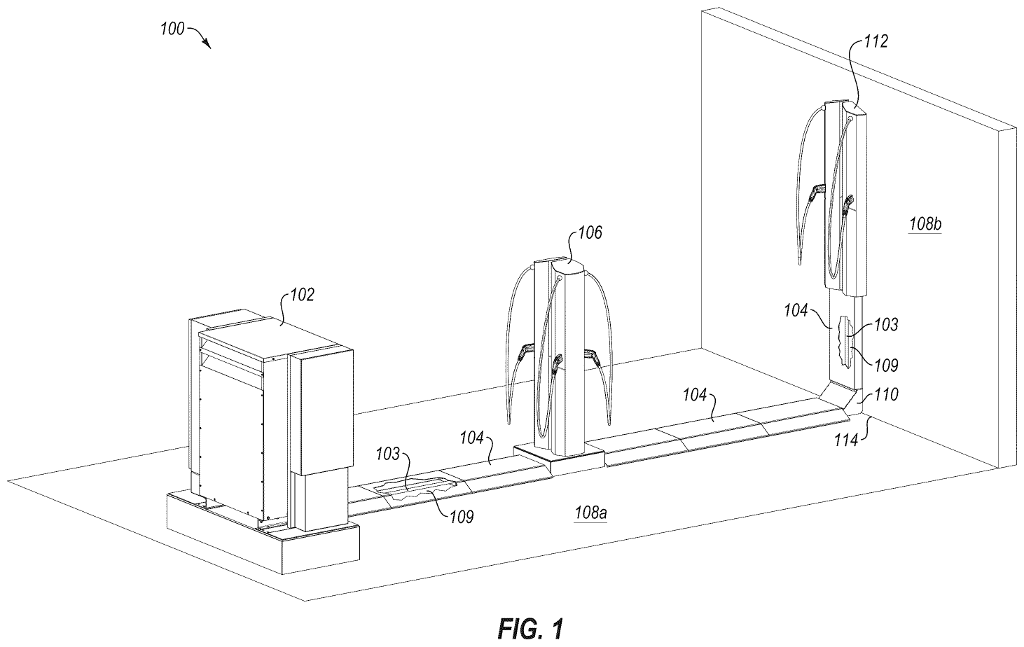

FIG. 1 illustrates an example EV charger system 100 (hereinafter system 100) that includes a power platform 102, a CMS 104, cables 103, a ground charger platform 106, and a wall charger platform 112. The system 100 is an example of a power installation. The power platform 102 may receive power from one or more power sources (not illustrated in FIG. 1) via the cables 103, which the power platform 102 regulates and transmits to the ground charger platform 106 and/or the wall charger platform 112 also via the cables 103. In this manner, the cables 103 may provide power from the power source to the power platform 102 and between the power platform 102 and the ground charger platform 106 and/or between the power platform 102 and the wall charger platform 112.

The ground charger platform 106 and the wall charger platform 112, as illustrated in FIG. 1, include EV chargers to provide power to and charge EV batteries. The ground charger platform 106 and/or the wall charger platform 112 may include other configurations such as power platforms to provide power to operate an external device, charger platforms to provide power to and charge batteries in other devices, or any other appropriate charger or power platforms.

As shown in FIG. 1, the ground charger platform 106 and the power platform 102 are installed on a first installation surface 108a (e.g., a ground surface). In addition, as shown in FIG. 1, the wall charger platform 112 is installed on a second installation surface 108b (e.g., a wall surface). The CMS 104 may extend between components of the system 100 on the corresponding installation surfaces 108a-b. For example, the CMS 104 may extend between the power platform 102 and the ground charger platform 106 on the first installation surface 108a, between the ground charger platform 106 and a CTS 110 also on the first installation surface 108a, and between the CTS 110 and the wall charger platform 112 on the second installation surface 108b.

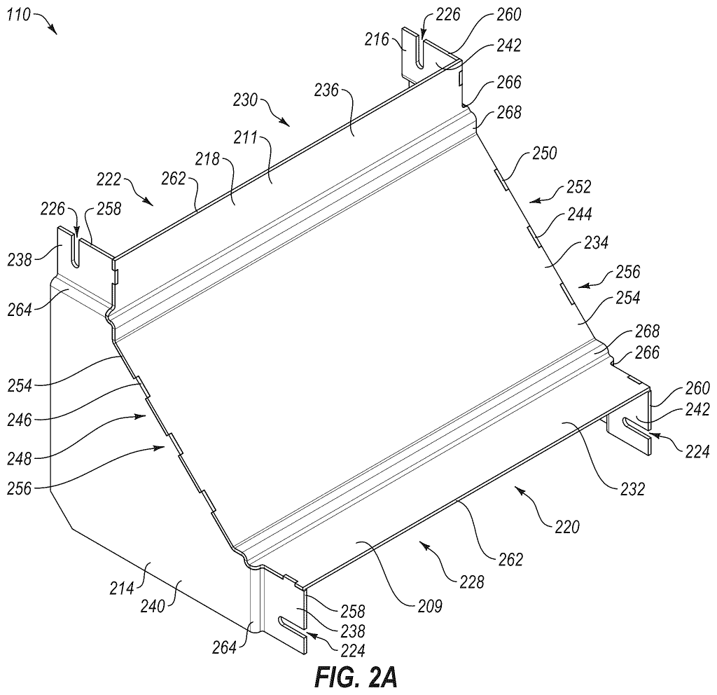

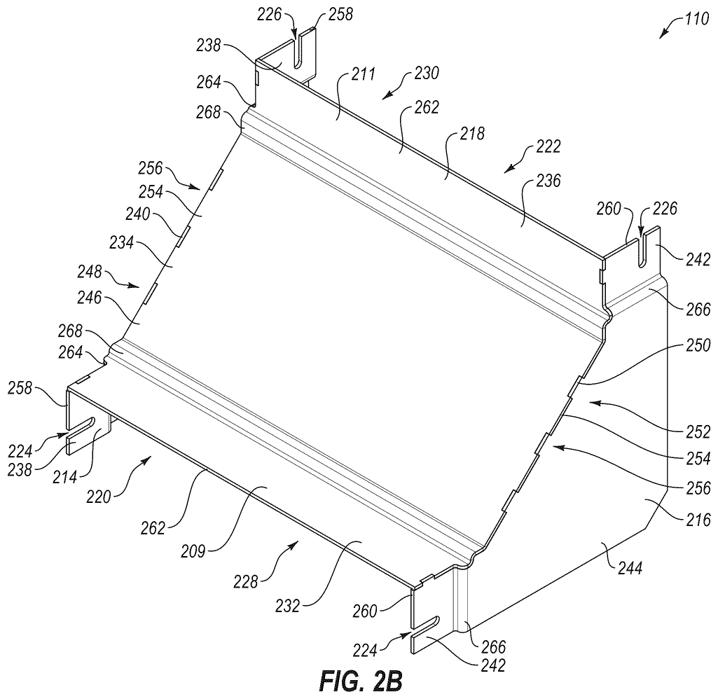

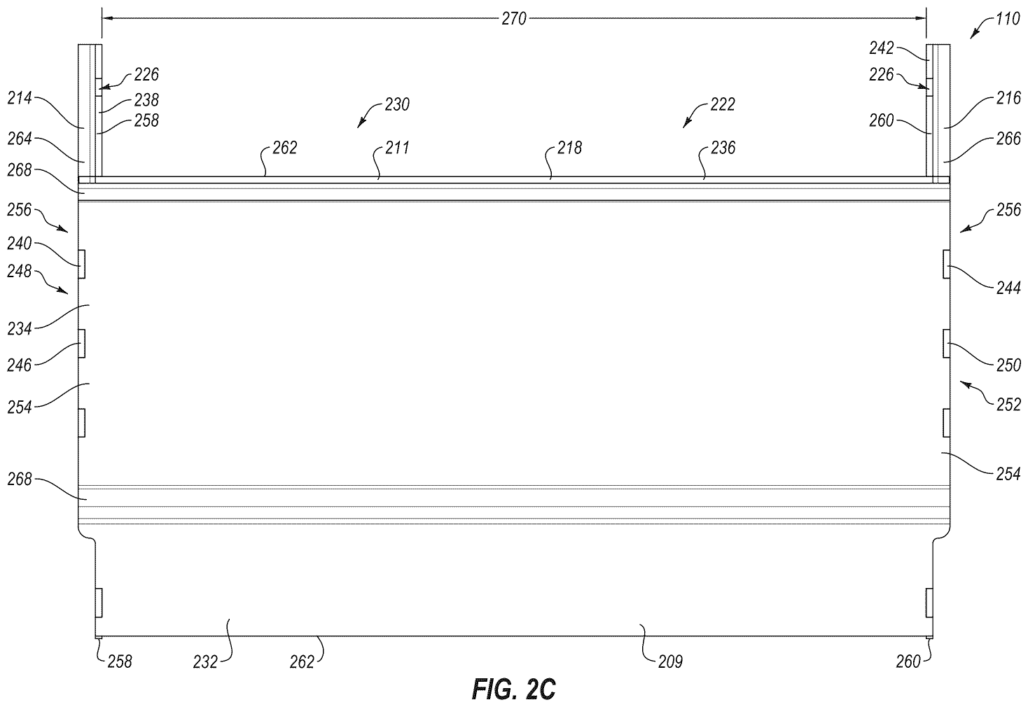

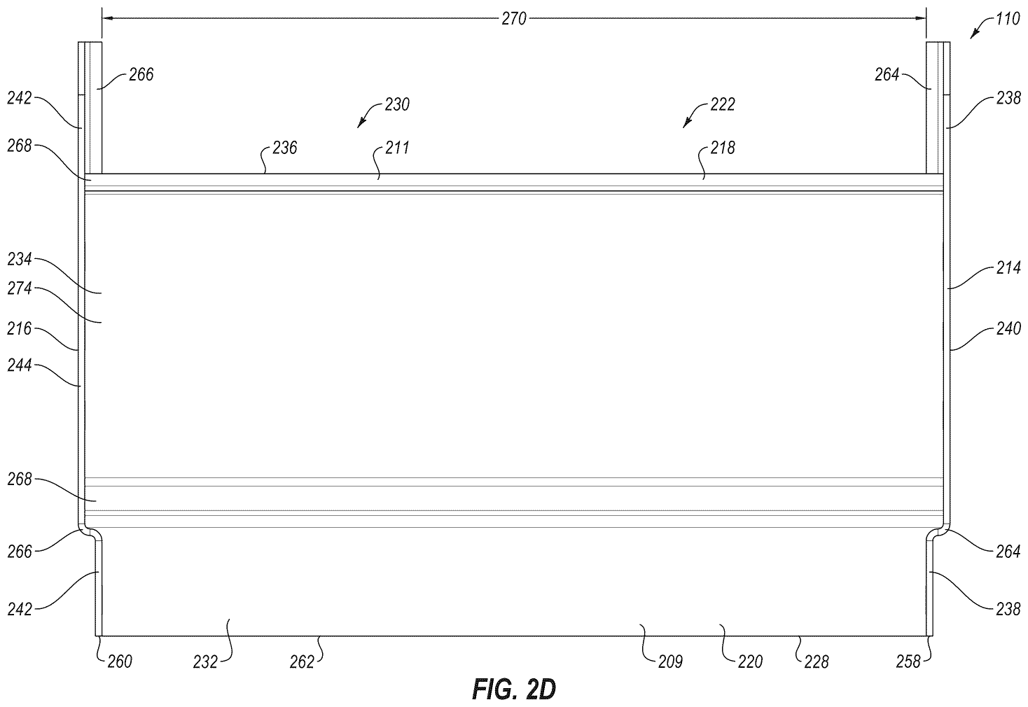

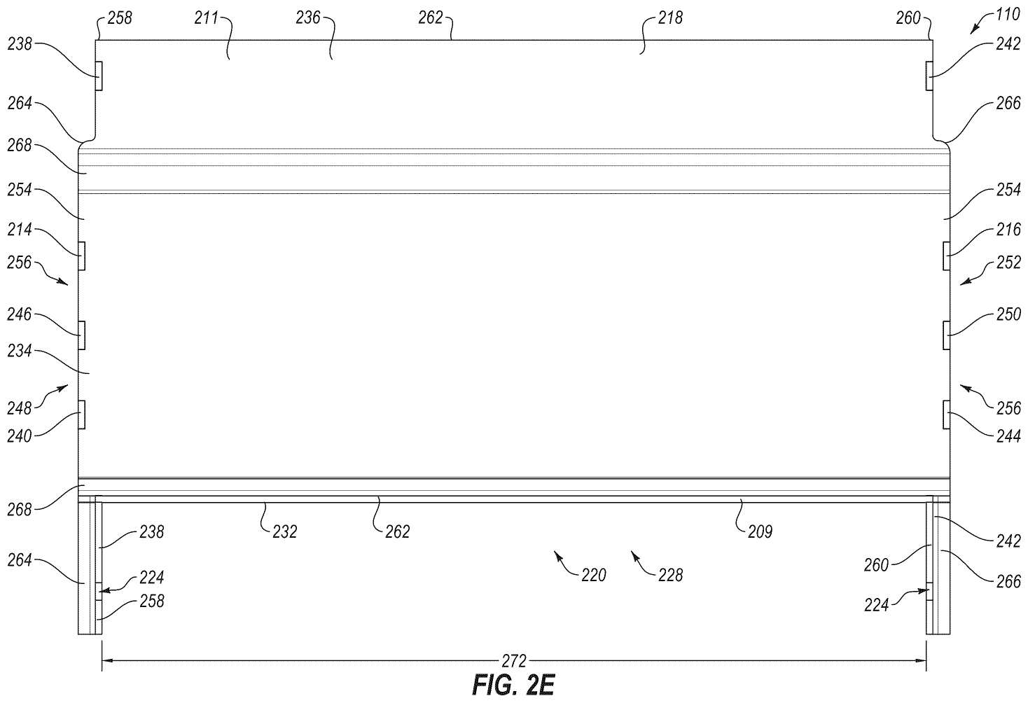

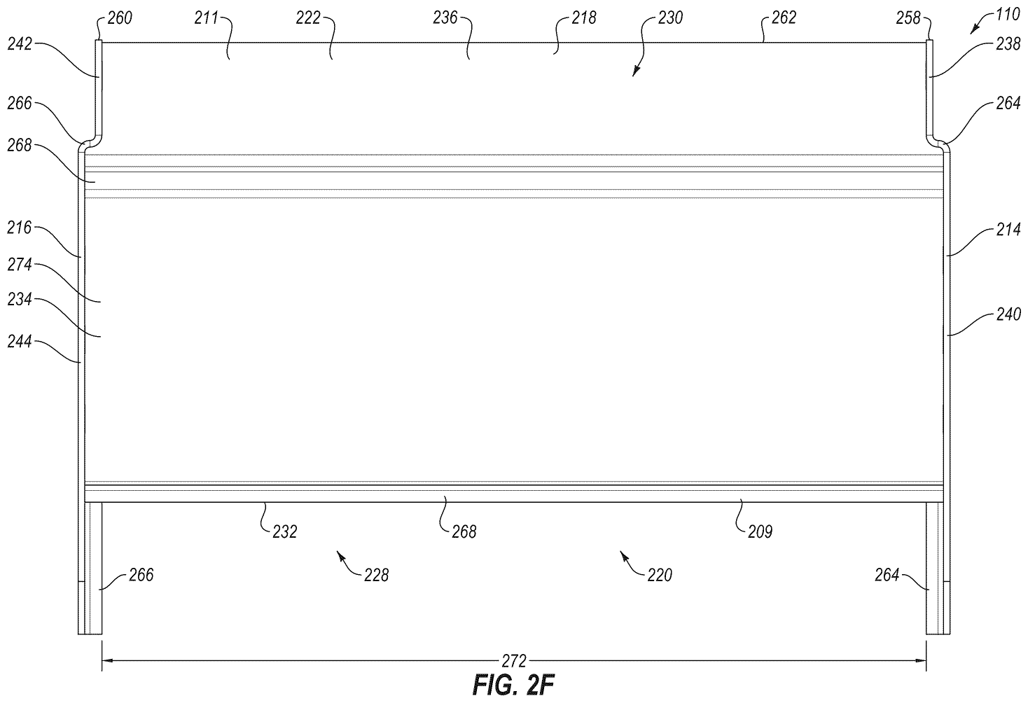

The CMS 104 in combination with the CTS 110 may function as an above-ground wiring run along the installation surfaces 108a-b and over a transition 114 between the first installation surface 108a and the second installation surface 108b. In particular, the CMS 104 may define internal volumes 109 that extend generally parallel to or along the first installation surface 108a and the second installation surface 108b and the CTS 110 may define volumes (such as denoted at 220 and 222 in FIGS. 2A-2F) that are connected to and/or at least partially included in the internal volumes 109 of the CMS 104 to route the cables 103 along the installation surfaces 108a-b. The transition 114 may be a change between the first installation surface 108a and the second installation surface 108b. For example, the first installation surface 108a may be a ground surface and the second installation surface 108b may be a wall surface that is generally orthogonal or otherwise non-parallel to the first installation surface 108a and the transition 114 may be a change between the ground surface and the wall surface. As used herein, “generally orthogonal” may include an angle between seventy-degrees and one hundred ten degrees. The transition 114 is illustrated in FIG. 1 as a ninety-degree change between the installation surfaces 108a-b for example purposes. However, it will be appreciated, with the benefit of the present disclosure, that the transition 114 may include other configurations such as a sloped change that is angled between ten degrees and one hundred thirty-five degrees relative to the first installation surface 108a.

With reference to FIGS. 1-3B, the CTS 110 may include a first sidewall 214, a second sidewall 216, and a top wall 218. The first sidewall 214 may be configured to engage the first installation surface 108a and the second installation surface 108b. The second sidewall 216 may also be configured to engage the first installation surface 108a and the second installation surface 108b. The top wall 218 may couple to and extend between the first sidewall 214 and the second sidewall 216.

The first sidewall 214, the second sidewall 216, and the top wall 218 may at least partially define a first opening 228 (shown in FIGS. 2A, 2B, 2E, and 2F) on a first plane 272 (shown in FIGS. 2E and 2F). The first plane 272 may extend along the first installation surface 108a. In some embodiments, the first sidewall 214, the second sidewall 216, and the top wall 218 along with the first installation surface 108a may define the first opening 228. The first opening 228 may receive the cables on the first plane 272 to permit the CTS 110 to route a part of the cables 103 along the first plane 272.

The first sidewall 214, the second sidewall 216, and the top wall 218 may at least partially define a first volume 220 (shown in FIGS. 2A, 2B, 2E, and 2F) that extends along the first plane 272. In some embodiments, the first sidewall 214, the second sidewall 216, and the top wall 218 along with the first installation surface 108a and/or the first opening 228 may define the first volume 220. The first volume 220 may route parts of the cables 103. In some embodiments, the first volume 220 may route parts of the cables 103 that extend generally parallel to the first plane 272. As used herein, “generally parallel” may include an angle between one hundred fifty degrees and two hundred ten degrees. Alternatively or additionally, the cables 103 within the first volume 220 may exhibit some curvature upward relative to the first plane 272 as the cables 103 transition from the first installation surface 108a to the second installation surface 108b.

The first sidewall 214, the second sidewall 216, and the top wall 218 may at least partially define a second opening 230 (shown in FIGS. 2A-2D) on a second plane 270 (shown in FIGS. 2C and 2D). The second plane 270 may extend along the second installation surface 108b. In some embodiments, the first sidewall 214, the second sidewall 216, and the top wall 218 along with the second installation surface 108b may define the second opening 230. The second opening 230 may receive the cables 103 on the second plane 270 to permit the CTS 110 to route a part of the cables 103 along the second plane 270.

The first sidewall 214, the second sidewall 216, and the top wall 218 may at least partially define a second volume 222 (shown in FIGS. 2A-2D) that extends along the second plane 270. In some embodiments, the first sidewall 214, the second sidewall 216, and the top wall 218 along with the second installation surface 108b and/or the second opening 230 may define the second volume 222. The second volume 222 may be configured to route parts of the cables 103. In some embodiments, the second volume 222 may route parts of the cables 103 that extend generally parallel to the second plane 270. Alternatively or additionally, the cables 103 within the second volume 222 may exhibit some curvature relative to the second plane 270 as the cables 103 transition from the first installation surface 108a to the second installation surface 108b.

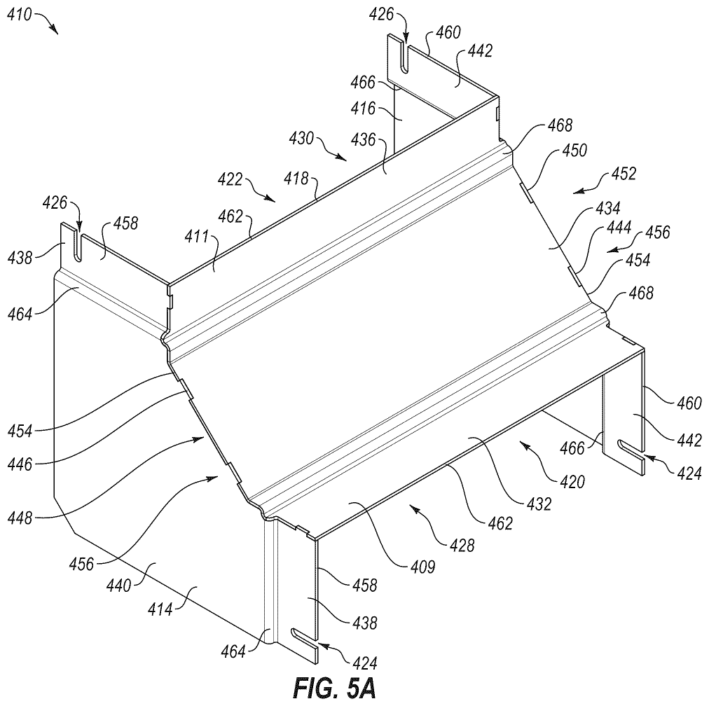

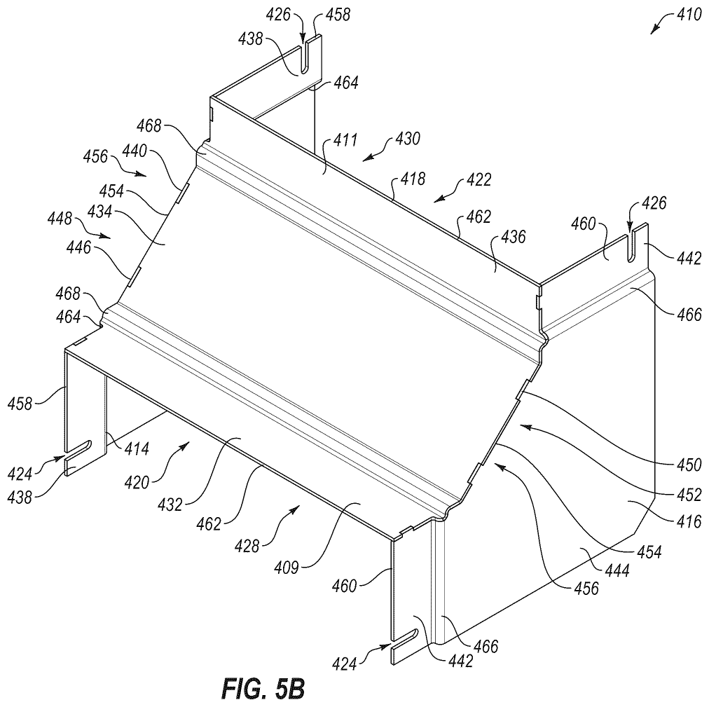

The first sidewall 214, the second sidewall 216, and the top wall 218 may at least partially define a transition volume 274 (shown in FIGS. 2D and 2F) that is connected between the first volume 220 and the second volume 222. In some embodiments, the first sidewall 214, the second sidewall 216, and the top wall 218 along with the first installation surface 108a and the second installation surface 108b may define the transition volume 274. The transition volume 274 may route parts of the cables 103 that extend between the first volume 220 and the second volume 222. The first volume 220, the second volume 222, and the transition volume 274 may form a contiguous volume for routing the cables 103 between the first opening 228 and the second opening 230 (e.g., through the CTS 110). An example of the cable 103 being routed through first volume 220, the second volume 222, and the transition volume 274 of the CTS 110 is described in more detail below in relation to FIG. 5.

The first sidewall 214 may include sidewall portions 238, transition portions 264, and a body sidewall portion 240. The sidewall portions 238 of the first sidewall 214 may extend along the first plane 272 and the second plane 270. In addition, the sidewall portions 238 of the first sidewall 214 may define parts of the first volume 220 and the second volume 222.

The transition portions 264 of the first sidewall 214 may be connected to the sidewall portions 238. The body sidewall portion 240 of the first sidewall 214 may be connected to the transition portions 264. The body sidewall portion 240 of the first sidewall 214 may be connected to the sidewall portions 238 via the transition portions 264. In addition, the body sidewall portion 240 of the first sidewall 214 may extend along both the first plane 272 and the second plane 270. Further, the body sidewall portion 240 of the first sidewall 214 may at least partially define the transition volume 274.

The second sidewall 216 may include sidewall portions 242, transition portions 266a-b, and a body sidewall portion 244. The sidewall portions 242 of the second sidewall 216 may extend along the first plane 272 and the second plane 270. In addition, the sidewall portions 242 of the second sidewall 216 may define parts of the first volume 220 and the second volume 222.

The transition portions 266 of the second sidewall 216 may be connected to the sidewall portions 242. The body sidewall portion 244 of the second sidewall 216 may be connected to the transition portions 266. The body sidewall portion 244 of the second sidewall 216 may be connected to the sidewall portions 242 via the transition portions 266. In addition, the body sidewall portion 244 of the second sidewall 216 may extend along both the first plane 272 and the second plane 270. Further, the body sidewall portion 244 of the second sidewall 216 may at least partially define the transition volume 274.

The top wall 218 may include a first portion 232, a body portion 234, a second portion 236, and transition portions 268. The first portion 232 may extend generally parallel to the first plane 272. In addition, the first portion 232 may at least partially define the first volume 220. The second portion 236 may extend generally parallel to the second plane 270. In addition, the second portion 236 may at least partially define the second volume 222. The body portion 234 may extend between the first portion 232 and the second portion 236. In addition, the body portion 234 may at least partially define the transition volume 274.

The transition portions 268 of the top wall 218 may be connected to the first portion 232, the body portion 234, or the second portion 236. The body portion 234 of the top wall 218 may extend diagonally from the transition portions 268.

In some embodiments, the CTS 110 (e.g., the first sidewall 214, the second sidewall 216, and the top wall 218) may interface with the CMS 104. In particular, an end 209 of the CTS 110 may interface with an end of the CMS 104 (e.g., an end of a first CMS). In addition, an end 211 of the CTS 110 may interface with another end of the CMS 104 (e.g., an end of a second CMS). The end 209 may include the corresponding sidewall portion 238 of the first sidewall 214, the first portion 232 of the top wall 218, and the corresponding sidewall portion 242 of the second sidewall 216. The end 211 may include the corresponding sidewall portion 238 of the first sidewall 214, the second portion 236 of the top wall 218, and the corresponding sidewall portion 242 of the second sidewall 216.

The transition portions 264 of the first sidewall 214 and the transition portions 266 of the second sidewall 216 may engage end surfaces of the CMS 104. The transition portions 264 of the first sidewall 214 and the transition portions 266 of the second sidewall 216 may engage with the end surfaces of the CMS 104 to limit a depth that the ends 209 and 211 may be positioned within the CMS 104.

At least portions of the ends 209 and 211 of the CTS 110 may be housed within the CMS 104. For example, at least a portion of the end 209 of the CTS 110 may be positioned within the internal volume 109 of the CMS 104 along the first plane 272. As another example, at least a portion of the end 211 of the CTS 110 may be positioned within the internal volume 109 of the CMS 104 along the second plane 270.

The end 209 of the CTS 110 may be received by the CMS 104 to connect the first volume 220 to the internal volume 109 of the CMS 104. In addition, the end 211 of the CTS 110 may be received by the CMS 104 to connect the second volume 222 to the internal volume 109 of the CMS 104. Further, the ends 209 and 211 of the CTS 110 may be housed within the CMS 104 to anchor the CTS 110 to the installation surfaces 108a-b via the CMS 104 and/or to prevent the CTS 110 from being removed or the cables 103 from being accessed.

The first sidewall 214 and the second sidewall 216 may define slots 224 (shown in FIGS. 2A, 2B, and 2E) that extend parallel to the first plane 272. The slots 224 may receive parts of the CMS 104 to position the CTS 110 relative to the CMS 104 along the first plane 272. For example, the slots 224 may receive (e.g., mate with) ground studs of the CMS 104.

The first sidewall 214 and the second sidewall 216 may define slots 226 (shown in FIGS. 2A-2C) that extend parallel to the second plane 270. The slots 226 may receive parts of the CMS 104 to position the CTS 110 relative to the CMS 104 along the second plane 270. For example, the slots 226 may receive (e.g., mate with) ground studs of the CMS 104.

In some embodiments, the first sidewall 214 and/or the second sidewall 216 may engage with the CMS 104 (e.g., the ground studs) via the slots 224 and/or 226 to electrically couple the CTS 110 to the CMS 104.

The first sidewall 214 may include an edge 246 that includes an interlocking portion 248. In addition, the second sidewall 216 may include an edge 250 that includes an interlocking portion 252. Further, the top wall 218 may include edges 254 that include corresponding interlocking portions 256. In some embodiments, the interlocking portions 248, 252, 256 may include a tongue and groove configuration. The interlocking portions 256 of the top wall 218 may mate with and/or be complementary to the interlocking portions 248 and 252 of the first sidewall 214 and the second sidewall 216.

The interlocking portions 256 of the top wall 218 may mate with the interlocking portions 248 and 252 of the first sidewall 214 and the second sidewall 216 to position the top wall 218 relative to the first sidewall 214 and the second sidewall 216. In some embodiments, the mating results in ends 262 of the top wall 218 being flush with corresponding ends 258 of the first sidewall 214 and corresponding ends 260 of the second sidewall 216 as illustrated in FIGS. 2A-2F.

The CTS 110 may include a metal material. For example, the CTS 110 may include sheet metal, an aluminum material, a steel material, or some combination thereof. In addition, the CTS 110 may include a material that is strong enough to withstand loads without internal structures within the first volume 220, the second volume 222, and/or the transition volume 274. For example, the CTS 110 may include a ⅛^{th} inch metal material. The CTS 110 may be treated to prevent corrosion due to environmental factors such as rain, snow, humidity, or any other environmental factor. For example, the CTS 110 may include a galvanized material, a powder coated material, or any other appropriate material.

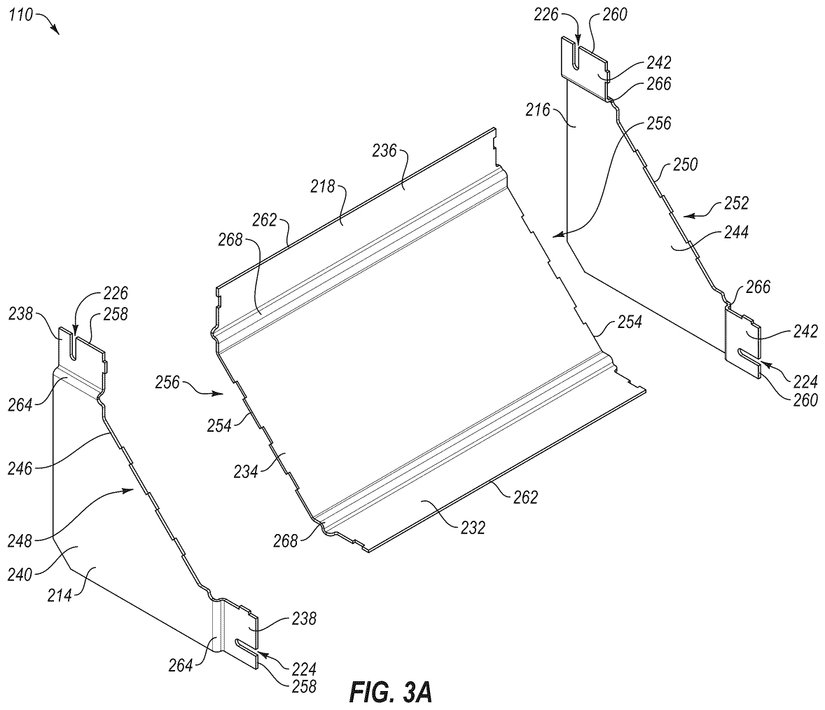

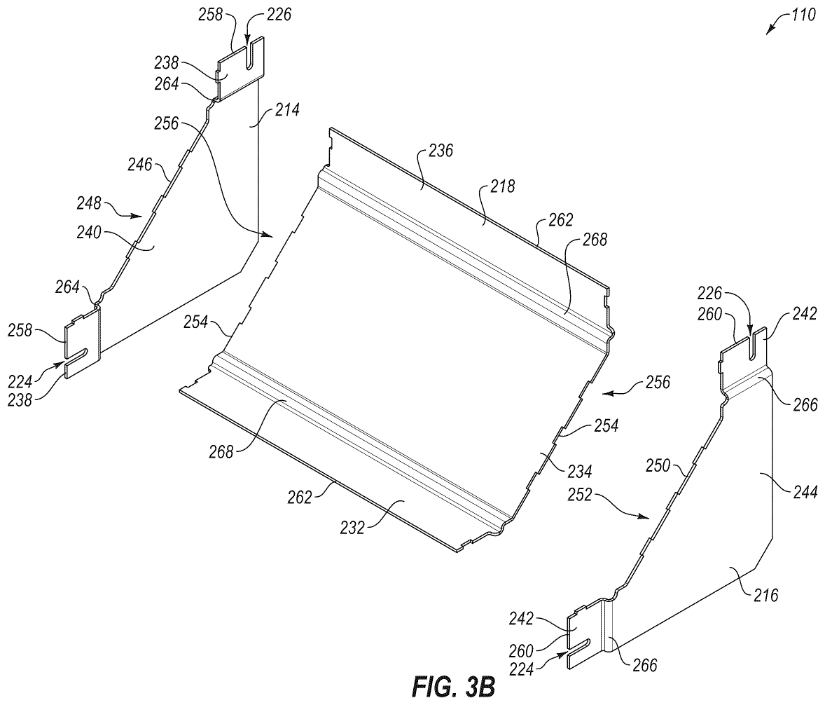

The ends 209 and 211 of the CTS 110 are illustrated in FIGS. 2A-3B as including rectangular shapes for example purposes. However, it will be appreciated, with the benefit of the present disclosure, that the shapes of the ends 209 and 211 may include any appropriate or desired shape such as a trapezoidal shape, a circular shape, a diamond shape, or any other appropriate or desired shape, e.g., any shape that is complementary to and/or that mates with a corresponding CMS. In addition, the CTS 110 is illustrated and described in relation to FIGS. 1-3B as the ends 209 and 211 being received by the CMS 104. Stated another way, each of the ends 209 and 211 may be substantially surrounded by corresponding ends of the CMS 104. However, it will be appreciated, with the benefit of the present disclosure, that one or both of the ends 209 and 211 of the CTS 110 may receive an end of the CMS 104 to connect the internal volume 109 of the CMS 104 and the volumes 220, 222 of the CTS 110. For example, the end 209 of the CTS 110 may receive the end of the CMS 104 and the end 211 of the CTS 110 may be received by the CMS 104. As another example, the end 209 of the CTS 110 may be received by the end of the CMS 104 and the end 211 of the CTS 110 may receive the end of the CMS 104. As yet another example, the end 209 of the CTS 110 may receive the end of the CMS 104 and the end 211 of the CTS 110 may receive another end of the CMS 104.

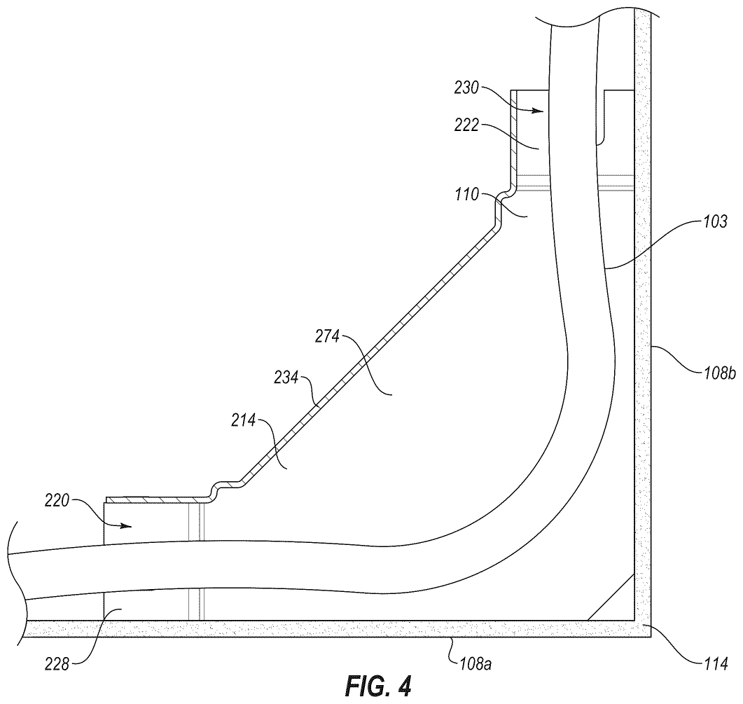

With reference to FIG. 4, the CTS 110 may route the cable 103 along at least a portion of the installation surfaces 108a-b and along the transition 114. In particular, the cable 103 may be received by the CTS 110 via the second opening 230 and the cable 103 may traverse the second volume 222 along the second installation surface 108b, traverse the transition volume 274 to transition between the second volume 222 and the first volume 220, and traverse the first volume 220 along the first installation surface 108a such that the CTS 110 may provide the cable 103 via the first opening 228. Additionally or alternatively, the cable 103 may be received by the CTS 110 via the first opening 228. Further, the cable 103 may traverse the first volume 220 along the first installation surface 108a, traverse the transition volume 274 to transition between the second volume 222 and the first volume 220, and traverse the second volume 222 along the second installation surface 108b such that the CTS 110 may provide the cable 103 via the second opening 230.

With reference to FIGS. 5A and 5B, a double CTS 410 is illustrated. The double CTS 410 may be similar or comparable to the CTS 110 of FIGS. 2A-3B, but includes a first sidewall 414, a second sidewall 416, and a top wall 418 that include greater heights compared to the first sidewall 214, the second sidewall 216, and the top wall 218 of the CTS 110 of FIGS. 2A-3B.

The double CTS 410 may include volumes that are larger than the volumes of the CTS 110 of FIGS. 2A-3B due to the greater heights. For example, a first volume 420 of the double CTS 410 may be greater than the first volume 220 of the CTS 110. As another example, a second volume 422 of the double CTS 410 may be greater than the second volume 222 of the CTS 110. As yet another example, a transition volume (not illustrated in FIGS. 5A and 5B) of the double CTS 410 may be greater than the transition volume 274 of the CTS 110. The greater volumes may permit the double CTS 410 to house stacked cables 103 or more cables 103 than the CTS 110. Additionally or alternatively, the greater volumes may permit the double CTS 410 to house cables 103 that are stiffer and need a larger bend radius.

The double CTS 410 may include the first sidewall 414, the second sidewall 416, and the top wall 418. The first sidewall 414 may be configured to engage the first installation surface 108a and the second installation surface 108b. The second sidewall 416 may also be configured to engage the first installation surface 108a and the second installation surface 108b. The top wall 418 may be coupled to and extend between the first sidewall 414 and the second sidewall 416.

The first sidewall 414, the second sidewall 416, and the top wall 418 may at least partially define a first opening 428 on a first plane (not illustrated in FIGS. 5A and 5B). The first plane may extend along the first installation surface 108a. In some embodiments, the first sidewall 414, the second sidewall 416, and the top wall 418 along with the first installation surface 108a may define the first opening 428. The first opening 428 may receive the cables on the first plane to permit the double CTS 410 to route a part of the cables 103 along the first plane.

The first sidewall 414, the second sidewall 416, and the top wall 418 may at least partially define the first volume 420 that extends along the first plane. In some embodiments, the first sidewall 414, the second sidewall 416, and the top wall 418 along with the first installation surface 108a and/or the first opening 228 may define the first volume 420. The first volume 420 may route parts of the cables. In some embodiments, the first volume 420 may route parts of the cables 103 that extend generally parallel to the first plane. Alternatively or additionally, the cables 103 within the first volume 420 may exhibit some curvature upward relative to the first plane as the cables 103 transition from the first installation surface 108a to the second installation surface 108b.

The first sidewall 414, the second sidewall 416, and the top wall 418 may at least partially define a second opening 430 on a second plane (not illustrated in FIGS. 5A and 5B). The second plane may extend along the second installation surface 108b. In some embodiments, the first sidewall 414, the second sidewall 416, and the top wall 418 along with the second installation surface 108b may define the second opening 430. The second opening 430 may receive the cables 103 on the second plane to permit the double CTS 410 to route a part of the cables 103 along the second plane.

The first sidewall 414, the second sidewall 416, and the top wall 418 may at least partially define the second volume 422 that extends along the second plane. In some embodiments, the first sidewall 414, the second sidewall 416, and the top wall 418 along with the second installation surface 108b and the/or the second opening 430 may define the second volume 422. The second volume 422 may route parts of the cables 103. In some embodiments, the second volume 422 may route parts of the cables 103 that extend generally parallel to the second plane. Alternatively or additionally, the cables 103 within the second volume 422 may exhibit some curvature relative to the second plane as the cables 103 transition from the first installation surface 108a to the second installation surface 108b.

The first sidewall 414, the second sidewall 416, and the top wall 418 may at least partially define the transition volume that is connected between the first volume 420 and the second volume 422. In some embodiments, the first sidewall 414, the second sidewall 416, and the top wall 418 along with the first installation surface 108a and the second installation surface 108b may define the transition volume. The transition volume may route parts of the cables 103 that extend between the first volume 420 and the second volume 422. The first volume 420, the second volume 422, and the transition volume may form a contiguous volume for routing the cables 103 between the first opening 428 and the second opening 430 (e.g., through the CTS 110).

The first sidewall 414 may include sidewall portions 438, transition portions 464, and a body sidewall portion 440. The sidewall portions 438 of the first sidewall 414 may extend along the first plane and the second plane. In addition, the sidewall portions 438 of the first sidewall 414 may define parts of the first volume 420 and the second volume 422.

The transition portions 464 of the first sidewall 414 may be connected to the sidewall portions 438. The body sidewall portion 440 of the first sidewall 414 may be connected to the transition portions 464. The body sidewall portion 440 of the first sidewall 414 may be connected to the sidewall portions 438 via the transition portions 464. In addition, the body sidewall portion 440 of the first sidewall 414 may extend along both the first plane and the second plane. Further, the body sidewall portion 440 of the first sidewall 414 may at least partially define the transition volume.

The second sidewall 416 may include sidewall portions 442, transition portions 466, and a body sidewall portion 444. The sidewall portions 442 of the second sidewall 416 may extend along the first plane and the second plane. In addition, the sidewall portions 442 of the second sidewall 416 may define parts of the first volume 420 and the second volume 422.

The transition portions 466 of the second sidewall 416 may be connected to the sidewall portions 442. The body sidewall portion 444 of the second sidewall 416 may be connected to the transition portions 466. The body sidewall portion 444 of the second sidewall 416 may be connected to the sidewall portions 442 via the transition portions 466a-b. In addition, the body sidewall portion 444 of the second sidewall 416 may extend along both the first plane and the second plane. Further, the body sidewall portion 444 of the second sidewall 416 may at least partially define the transition volume.

The top wall 418 may include a first portion 432, a body portion 434, a second portion 436, and transition portions 468. The first portion 432 may extend generally parallel to the first plane. In addition, the first portion 432 may at least partially define the first volume 420. The second portion 436 may extend generally parallel to the second plane. In addition, the second portion 436 may at least partially define the second volume 422. The body portion 434 may extend between the first portion 432 and the second portion 436. In addition, the body portion 434 may at least partially define the transition volume.

The transition portions 468 of the top wall 418 may be connected to the first portion 432, the body portion 434, and the second portion 436. The body portion 434 of the top wall 418 may extend diagonally from the transition portions 468.

In some embodiments, the double CTS 410 (e.g., the first sidewall 414, the second sidewall 416, and the top wall 418) may interface with the CMS 104. In particular, an end 409 of the double CTS 410 may interface with an end of the CMS 104 (e.g., an end of a first CMS). In addition, an end 411 of the double CTS 410 may interface with another end of the CMS 104 (e.g., an end of a second CMS). The end 409 may include the corresponding sidewall portion 438 of the first sidewall 414, the first portion 432 of the top wall 418, and the corresponding sidewall portion 442 of the second sidewall 416. The end 411 may include the corresponding sidewall portion 438 of the first sidewall 414, the second portion 436 of the top wall 418, and the corresponding sidewall portion 442 of the second sidewall 416.

The transition portions 464 of the first sidewall 414 and the transition portions 466 of the second sidewall 416 may engage end surfaces of the CMS 104. The transition portions 464 of the first sidewall 414 and the transition portions 466 of the second sidewall 416 may engage with the end surfaces of the CMS 104 to limit a depth that the ends 409 and 411 may be positioned within the CMS 104.

At least portions of the ends 409 and 411 of the double CTS 410 may be housed within the CMS 104. For example, at least a portion of the end 409 of the double CTS 410 may be positioned within the internal volume 109 of the CMS 104 along the first plane. As another example, at least a portion of the end 411 of the double CTS 410 may be positioned within the internal volume 109 of the CMS 104 along the second plane.

The end 409 of the double CTS 410 may be received by the CMS 104 to connect the first volume 420 to the internal volume 109 of the CMS 104. In addition, the end 411 of the CTS 110 may be received by the CMS 104 to connect the second volume 422 to the internal volume 109 of the CMS 104. Further, the ends 409 and 411 of the CTS 110 may be housed within the CMS 104 to anchor the double CTS 410 to the installation surfaces 108a-b via the CMS 104 and/or to prevent the double CTS 410 from being removed or the cables 103. from being accessed.

The first sidewall 414 and the second sidewall 416 may define slots 424 that extend parallel to the first plane. The slots 424 may receive parts of the CMS 104 to position the double CTS 410 relative to the CMS 104 along the first plane. For example, the slots 424 may receive (e.g., mate with) ground studs of the CMS 104.

The first sidewall 414 and the second sidewall 416 may define slots 426 that extend parallel to the second plane. The slots 426 may receive parts of the CMS 104 to position the double CTS 410 relative to the CMS 104 along the second plane. For example, the slots 426 may receive (e.g., mate with) ground studs of the CMS 104.

In some embodiments, the first sidewall 414 and/or the second sidewall 416 may engage with the CMS 104 (e.g., the ground studs) via the slots 424 and/or 426 to electrically couple the double CTS 410 to the CMS 104.

The first sidewall 414 may include an edge 446 that includes an interlocking portion 448. In addition, the second sidewall 416 may include an edge 450 that includes an interlocking portion 452. Further, the top wall 418 may include edges 454 that include corresponding interlocking portions 456. In some embodiments, the interlocking portions 448, 452, 456 may include a tongue and groove configuration. The interlocking portions 456 of the top wall 418 may mate with and/or be complementary to the interlocking portions 448 and 452 of the first sidewall 414 and the second sidewall 416.

The interlocking portions 456 of the top wall 418 may mate with the interlocking portions 448 and 452 of the first sidewall 414 and the second sidewall 416 to position the top wall 418 relative to the first sidewall 414 and the second sidewall 416. In some embodiments, the mating results in ends 462 of the top wall 418 being flush with corresponding ends 458 of the first sidewall 414 and corresponding ends 460 of the second sidewall 416 as illustrated in FIGS. 5A and 5B.

The double CTS 410 may include a metal material. For example, the double CTS 410 may include sheet metal, an aluminum material, a steel material, or some combination thereof. In addition, the double CTS 410 may include a material that is strong enough to withstand loads without internal structures within the first volume 420, the second volume 422, and/or the transition volume. For example, the double CTS 410 may include a ⅛^{th} inch metal material. The double CTS 410 may be treated to prevent corrosion due to environmental factors such as rain, snow, humidity, or any other environmental factor. For example, the double CTS 410 may include a galvanized material, a powder coated material, or any other appropriate material.

The ends 409 and 411 of the CTS 410 are illustrated in FIGS. 5A and 5B as including rectangular shapes for example purposes. However, it will be appreciated, with the benefit of the present disclosure, that the shapes of the ends 409 and 411 may include any appropriate or desired shape such as a trapezoidal shape, a circular shape, a diamond shape, or any other appropriate or desired shape, e.g., any shape that is complementary to and/or that mates with a corresponding CMS. In addition, the double CTS 410 is illustrated and described in relation to FIGS. 5A and 5B as the ends 409 and 411 being received by the CMS 104. Stated another way, each of the ends 409, 411 may be substantially surrounded by corresponding ends of the CMS 104. However, it will be appreciated, with the benefit of the present disclosure, that one or both of the ends 409 and 411 may receive an end of the CMS 104 to connect the internal volume 109 of the CMS 104 and the volumes 420, 422 of the double CTS 410. For example, the end 409 of the double CTS 410 may receive the end of the CMS 104 and the end 411 of the double CTS 410 may be received by the CMS 104. As another example, the end 409 of the double CTS 410 may be received by the end of the CMS 104 and the end 411 of the double CTS 410 may receive the end of the CMS 104. As yet another example, the end 409 of the double CTS 410 may receive the end of the CMS 104 and the end 411 of the double CTS 410 may receive another end of the CMS 104.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A cable transition system comprising:
a plurality of sidewalls and
a top wall configured to couple to and extend between the plurality of sidewalls to:
at least partially define a first volume extending along a first plane and the first volume is configured to route a part of a cable along the first plane;
at least partially define a second volume extending along a second plane that is non-parallel to the first plane and the second volume is configured to route a part of the cable along the second plane; and
at least partially define a transition volume connected to the first volume and the second volume and the transition volume is configured to route a part of the cable between the first volume and the second volume to permit the cable to extend along the first plane and the second plane.

2. The cable transition system of claim 1, wherein the plurality of sidewalls are configured to engage with a first surface extending along the first plane and to engage with a second surface extending along the second plane.

3. The cable transition system of claim 1, wherein:
the plurality of sidewalls define a slot extending parallel to the first plane; and
the slot is configured to receive a part of a cable management system to position the cable transition system relative to the cable management system to connect an internal volume of the cable management system and the first volume.

4. The cable transition system of claim 1, wherein:
the plurality of sidewalls and the top wall at least partially define a first opening configured to receive the cable on the first plane; and
the plurality of sidewalls and the top wall at least partially define a second opening configured to receive the cable on the second plane.

5. The cable transition system of claim 1, wherein the top wall comprises:
a first portion extending generally parallel to the first plane;
a body portion connected to the first portion; and
a second portion connected to the body portion and extending generally parallel to the second plane.

6. The cable transition system of claim 1, wherein the plurality of sidewalls comprise:
a first sidewall portion extending along the first plane;
a second sidewall portion extending along the second plane; and
a body sidewall portion connected to the first sidewall portion and the second sidewall portion, the body sidewall portion extending along the first plane and the second plane.

7. The cable transition system of claim 1, wherein:
the plurality of sidewalls comprise a first edge comprising a first interlocking portion; and
the top wall comprises a second edge comprising a second interlocking portion configured to mate with the first interlocking portion to position the top wall relative to the plurality of sidewalls such that ends of the plurality of sidewalls are flush with ends of the top wall.

8. The cable transition system of claim 1, wherein:
the plurality of sidewalls comprise:
a first sidewall portion that at least partially defines the first volume;
a first transition portion connected to the first sidewall portion;
a body sidewall portion connected to the first transition portion, the body sidewall portion at least partially defining the transition volume;
a second transition portion connected to the body sidewall portion; and
a second sidewall portion connected to the second transition portion, the second sidewall portion at least partially defining the second volume;
the first transition portion is configured to interface with an end of a first cable management system; and
the second transition portion is configured to interface with an end of a second cable management system.

9. The cable transition system of claim 1, wherein:
the top wall comprises:
a first portion that at least partially defines the first volume;
a first transition portion connected to the first portion;
a body portion extending diagonally from the first transition portion, the body portion at least partially defining the transition volume;
a second transition portion connected to the body portion; and
a second portion connected to the second transition portion, the second portion at least partially defining the second volume;
the first transition portion is configured to interface with an end of a first cable management system; and
the second transition portion is configured to interface with an end of a second cable management system.

10. The cable transition system of claim 1, wherein the second plane is generally orthogonal to the first plane.

11. A system comprising:
a first cable management system extending along a first plane and defining a first volume;
a second cable management system extending along a second plane that is non-parallel to the first plane and defining a second volume; and
a cable transition system coupled to the first cable management system and the second cable management system, the cable transition system comprising:
a plurality of sidewalls and
a top wall configured to couple to and extend between the plurality of sidewalls to:
at least partially define a third volume extending along the first plane and the third volume is configured to receive a cable from the first volume of the first cable management system and to route a part of the cable along the first plane;
at least partially define a fourth volume extending along the second plane and the fourth volume is configured to provide the cable to the second volume of the second cable management system and to route a part of the cable along the second plane; and
at least partially define a transition volume connected to the third volume and the fourth volume and the transition volume is configured to route a part of the cable between the third volume and the fourth volume to permit the cable to extend along the first plane and the second plane.

12. The system of claim 11,
wherein the plurality of sidewalls are configured to engage with a first surface extending along the first plane and to engage with a second surface extending along the second plane.

13. The system of claim 11, wherein:
the plurality of sidewalls define a slot extending parallel to the first plane; and
the slot is configured to receive a part of the first cable management system to position the cable transition system relative to the first cable management system.

14. The system of claim 11, wherein:
the plurality of sidewalls and the top wall at least partially define a first opening configured to receive the cable on the first plane; and
the plurality of sidewalls and the top wall at least partially define a second opening configured to receive the cable on the second plane.

15. The system of claim 11, wherein the top wall comprises:
a first portion extending generally parallel to the first plane;
a body portion connected to the first portion; and
a second portion connected to the body portion and extending generally parallel to the second plane.

16. The system of claim 11, wherein the plurality of sidewalls comprise:
a first sidewall portion extending along the first plane;
a second sidewall portion extending along the second plane; and
a body sidewall portion connected to the first sidewall portion and the second sidewall portion, the body sidewall portion extending along the first plane and the second plane.

17. The system of claim 11, wherein:
the plurality of sidewalls comprise a first edge comprising a first interlocking portion; and
the top wall comprises a second edge comprising a second interlocking portion configured to mate with the first interlocking portion to position the top wall relative to the plurality of sidewalls such that ends of the plurality of sidewalls are flush with ends of the top wall.

18. The system of claim 11, wherein:
the plurality of sidewalls comprise:
a first sidewall portion that at least partially defines the third volume;
a first transition portion connected to the first sidewall portion;
a body sidewall portion connected to the first transition portion, the body sidewall portion at least partially defining the transition volume;
a second transition portion connected to the body sidewall portion; and
a second sidewall portion connected to the second transition portion, the second sidewall portion at least partially defining the fourth volume;
the first transition portion is configured to interface with an end of the first cable management system; and
the second transition portion is configured to interface with an end of the second cable management system.

19. The system of claim 11, wherein:
the top wall comprises:
a first portion that at least partially defines the third volume;
a first transition portion connected to the first portion;
a body portion extending diagonally from the first transition portion, the body portion at least partially defining the transition volume;
a second transition portion connected to the body portion; and
a second portion connected to the second transition portion, the second portion at least partially defining the fourth volume;
the first transition portion is configured to interface with an end of the first cable management system; and
the second transition portion is configured to interface with an end of the second cable management system.

20. The system of claim 11, wherein the second plane is generally orthogonal to the first plane.
